(19) United States
(12) Patent Application Publication
(10) Pub. No.: US 2010/0030652 A1
(43) Pub. Date: Feb. 4, 2010

(54) Hosting Interactive Management System

(75) Inventors: Lior Gazit, Kfar Saba (IL); Idan Sandomirsky, Kfar Saba (IL); Adi Chitayat, Kfar Saba (IL)

Correspondence Address: William H. Dippert;Eckert Seamans Cherin & Mellott, LLC, U.S. Steel Tower, 600 Grant Street, 44th Floor, Pittsburgh, PA, 15219, US

(73) Assignee: CONCEPTIC LTD., Kfar Saba (IL)

(21) Appl. No.: 11/817,701

(22) PCT Filed: Mar. 2, 2006
(86) PCT No.: PCT/IL06/00294

§ 371 Date: Sep. 25, 2009

Related U.S. Application Data
(60) Provisional application No. 60/658,101, filed on Mar. 2, 2005.

(51) Int. Cl. G06Q 99/00; G06Q 30/00; G06F 3/048; G06Q 50/00; G06F 15/16

(52) U.S. Cl. 705/21; 715/760; 709/204; 705/1

(57) ABSTRACT

The present invention provides a computerized and interactive hosting management system adapted to facilitate communication between customers and service providers. The interactive system can be utilized in restaurants, caf?s, diners, hotels, theaters, resorts and the like. The present invention is provided with identification means so as to allow identification of the customers using the facilities of the place. Identifying the customers using the system is effective so as to build up a true interactive system.

### FIELD OF THE INVENTION

The present invention relates to hosting management systems. More particularly, the present invention relates to interactive computerized hosting system in which communication between customers and service providers is effective and efficient. The hosting facilities that can substantially benefit such computerized interactive management systems are restaurants, hotels, clubs and the like.

### BACKGROUND OF THE INVENTION

Most ordering systems available nowadays in restaurants, resorts, motels, hotels, spa resorts, budget accommodation, karaoke clubs, cafés, diners, etc. are already computerized. The computerized systems are aimed at providing an efficient and easy means to communicate with the customer as well as maintaining a proper database of customers. However, in most available systems, the customer acquires the needed information and makes the order through a hostess, waiter or other personnel that intermediates between the customer and the ordering system.

Attempts were made in order to provide a system in which the customer can communicate directly with the computerized system. An ordering system for restaurants is disclosed in U.S. Pat. No. 6,208,976 “Order management system with automatic menu updating” by Kinebuchi et al. in 1996. This order management system enables a customer to use a terminal device to order food, but can respond rapidly to changes and additions to the menu. When this system starts up, it transmits an operating program and image data from main management equipment to each of the number of order-taking terminal devices. Each order-taking terminal stores the received operating program and image data and displays a menu screen on a display screen on the basis of the stored operating program and image data. Another example of interactive communication between the personnel of a restaurant and the customers is disclosed in U.S. Pat. No. 6,636,835 “Wireless maitre D' system for restaurants” by Ragsdale-Elliotte et al. and filed in 2001. This patent describes a wireless maitre D' system and method for providing interactive two-way communication between patrons and restaurant service personnel who have direct interaction with the patrons during restaurant encounters,

A system that is easy to be used by the customer is taught in PCT application published as WO 03/091960 “Ordering service system in restaurant and the like” by Eguchi et al. This ordering service system makes use of a touch panel having a function considered to greatly contribute to shop advertisement and sales increase or promotions. The order service system includes order input means arranged on a user table of a restaurant or a like. The order input means has a touch panel displaying menu contents that a user can select by touching. By using a display such as display menu and order data displayed on the touch panel as a game element, a game is set in a playing form or a prize and a quiz form in the management computer so that the user can perform the game on the touch panel by touching/operating the game display displayed on the touch panel.

The described systems as well as other available systems are adapted to ease and facilitate the communication between the personnel of the restaurant and the customer; however, they are still lack of many advantages that can be gained by a computerized system. Moreover, the database that is developed in the ordering systems that are described in the patents brought herein as references cannot be used in an effective manner and are basically plain data contained in the menu and prices.

### SUMMARY OF THE INVENTION

It is an object of the present invention to provide a computerized and interactive hosting system adapted to facilitate communication between customers and service providers. The interactive system can be utilized in restaurants, cafés, diners, hotels, theaters, resorts etc.

It is another object of the present invention to provide identification means on each table of a restaurant so as to allow identification of the people using the facilities of the place. Identifying the people using the system is effective so as to build up a true interactive system.

It is yet another object of the present invention to provide entertainment means on each table of a restaurant, club, or any other facility.

Therefore, there is provided in accordance with a preferred embodiment of the present invention, a hosting management system adapted to provide communication between service provider and customer in a location, the system comprising:
a server;
at least one customer computer system provided in the location communicating with said server and provided with identification means adapted to identify the customer.

Furthermore and in accordance with another preferred embodiment of the present invention, the system is further provided with at least one service provider computer unit communicating with said server.

Furthermore and in accordance with another preferred embodiment of the present invention, said at least one service provider computer unit is provided with identification means.

Furthermore and in accordance with another preferred embodiment of the present invention, a plurality of input devices is communicating with said at least one service provider computer unit.

Furthermore and in accordance with another preferred embodiment of the present invention, said identification means is a biometric means.

Furthermore and in accordance with another preferred embodiment of the present invention, Internet is provided to said server or/and to said at least one customer computer server.

Furthermore and in accordance with another preferred embodiment of the present invention, the system is further provided with cash register communicating with said server.

Furthermore and in accordance with another preferred embodiment of the present invention, said cash register is communicating with at least one of said at least one service provider computer unit.

Furthermore and in accordance with another preferred embodiment of the present invention, said location is selected from a group of locations such as restaurants, resorts, motels, hotels, spa resorts, budget accommodation, karaoke clubs, cafés, diners.

Furthermore and in accordance with another preferred embodiment of the present invention, a plurality of input devices is communicating with said at least one customer computer system.

Furthermore and in accordance with another preferred embodiment of the present invention, said at least one customer computer is adapted to provide on-line information related to the location.

Furthermore and in accordance with another preferred embodiment of the present invention, said server is communicating with said at least one customer computer systems using web architecture.

Furthermore and in accordance with another preferred embodiment of the present invention, said at least one customer computer system is a terminal of said server.

Furthermore and in accordance with another preferred embodiment of the present invention, said server is provided with an updated database provided with information related to the customer.

It is further provided in accordance with another preferred embodiment of the present invention, an improvement for a management hosting system providing communication between service provider and customer wherein the improvement comprises an identification means associated with the customer.

In addition, in accordance with another preferred embodiment of the present invention, said identification means is biometric.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 illustrates a hosting management system in accordance with a preferred embodiment of the present invention.

FIG. 2 illustrates illustrated a block diagram of terminal-server architecture for a hosting management system of the present invention

FIG. 3 illustrates a hosting management system in accordance with another preferred embodiment of the present invention.

FIG. 4 illustrates a block diagram of terminal-server architecture for a hosting management system of the present invention.

FIG. 5 illustrates a block diagram of web architecture for a hosting management system in accordance with another preferred embodiment of the present invention.

FIG. 6 illustrates a block diagram of web architecture for a hosting management system in accordance with yet another preferred embodiment of the present invention.

### DETAILED DESCRIPTION OF THE INVENTION AND FIGURES

The present invention provides a new and useful computerized hosting system that is interactive with the customer. The comprehensive interactivity between the hosting system and the customer is accomplished by providing the hosting system with an identification means by which the customer is identified before the system that “knows” his needs and habits and is adapted to learn from every interaction and update the database of the system. The identification means of the hosting system is preferably a biometric means; however, it can be any other method of identification such as identification card, code or usage of RFID technologies. Additional identification means can be utilized by using a cellular phone by which the customer is sending an SMS message or a predetermined number by which he is identifies by the management hosting system that has the relevant information stored in a customer database.

In accordance with one aspect of the present invention, the hosting management system is provided with a server to which a plurality of terminals is connected. The terminals can be customer terminals and service provider's terminals. Each customer terminal is provided with an identification means by which the customer is identified before the system. It is possible that the service provider's terminal will be also provided with identification means so that the personnel that is treating the customer will be identified also and if a change occurs, it is recorded by the system.

In accordance with another aspect of the present invention, the management hosting system is built in a web architecture in which a plurality of connected computers are provided to the customers as well as to the service providers and are connected to a Web Servers Farm

The examples that are given herein are referred to hosting management systems that are provided in restaurant facility; however, similar management and communication systems can be employed in diners, hotels, resorts, spa's, guest rooms, stadiums, theaters, clubs etc.

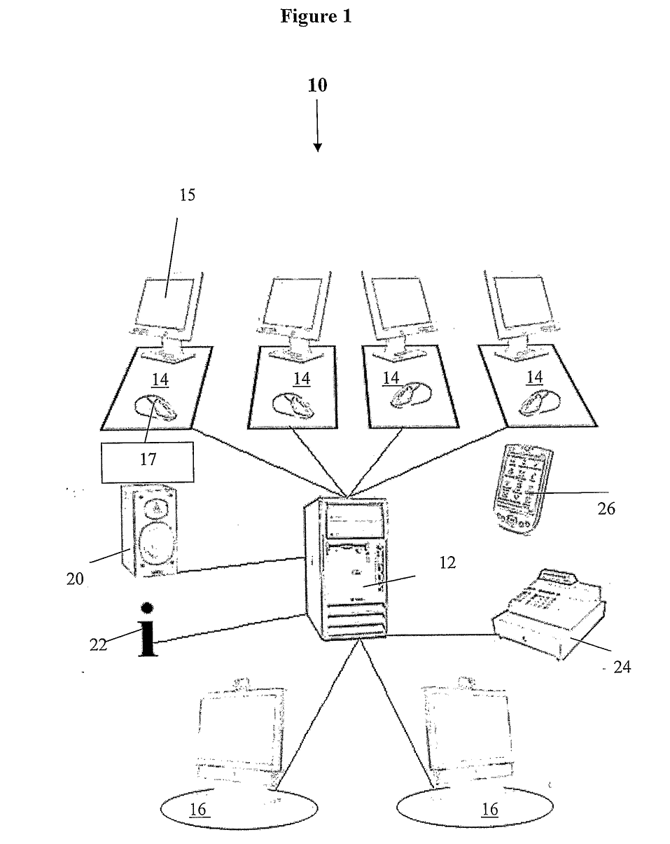

Reference is now made to FIG. 1 illustrating a hosting management system in accordance with a preferred embodiment of the present invention. Management system 10 comprises a server 12 that is provided with communication elements that electrically connects server 12 to two main cores—the customers and the service providers. Customer's computer systems 14 are connected to server 12 and can be optionally connected to a web such as the Internet web through server 12. Customer computer 14 can be provided on each table in the restaurant; however, it can be provided on several tables so that for every few tables, input/output elements are provided. Waiter communication units 16 are the second core that is electrically connected to server 12. Customer computer 14 can comprise different input or output means such as a monitor 15 and a mouse 17. It is optional that the monitor will be provided with a touch screen so as to facilitate the interaction of the customer with the computerized hosting system. The touch screen can also be provided with biometric means in order to facilitate the identification of the customer.

As mentioned herein before, one of the features rendering the present invention its uniqueness is identification means that enables the system to identify the customer. In the hosting management system shown in FIG. 1, the identification means is provided in computer mouse 17. When the customer is communicating with the system, he does it through the computer mouse. Computer mouse 17 is provided with a biometric device that is adapted to identify the user through comparing his fingerprint to a database of fingerprints. The database is provided within server 12. If the fingerprint of the customer is identified by the system, the system can interact with the customer in accordance with the data provided within the system. The biometric device facilitates the identification of the customer that is desired from several reasons:
1. Security reasons—the system will communicate and interact with an identified customer only.
2. The system can keep records of the customer's habits or sensitivities.
3. Different payment possibilities—credit card payment that is authorized by the fingerprint of the biometric mouse, upfront payment, etc.
4. biometric identification for belongings.

The use of a biometric mouse or any mouse instead of a touch screen is that any person that seats near the table has an access to the mouse and the touch screen can be located distantly of the table so as to allow comfort. One monitor screen can serve more than one table. It is optional to provide a feature by which after the customer was identified, the system enables him to view the menu without ordering. The system then provides him with specially designed menu and specially designed prices that are processed using the database that is provided with information regarding the basic needs and special desires of the specific customer. The identification procedure can be utilized at any time during the interaction of the customer with the system.

The customer is interacting with the hosting management system through the mouse and the monitor in order to see the menu, order, play, surf, and pay.

Hosting management system 10 is optionally and further provided with speakers 20 that are communicating with server 12. Furthermore, Internet 22 is provided to server 12 so that the internet can be used through customer computer systems 14 or through waiter units 16. It should be mentioned that the Internet can be also provided directly to the customer's computers. A cash register 24 of the restaurant is communicating with hosting management system 10 through server 12.

It should be mentioned that the elements of the hosting management system can be electrically connected such as shown in the Figure; however, wireless communication can be utilized in the system. The transition of the system from a wired system to a wireless is obvious to a man skilled in the art.

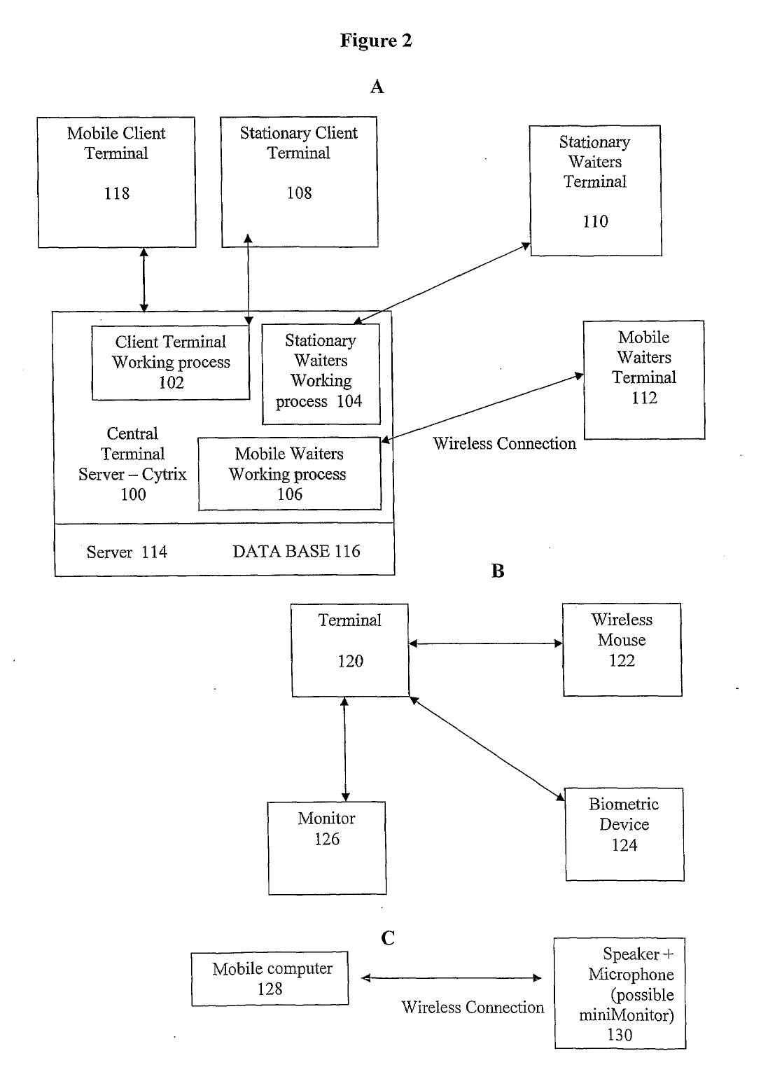

Reference is now made to FIG. 2 illustrating a block diagram of terminal-server architecture for a hosting management system of the present invention that can be implemented in a system shown in FIG. 1. The terminals-server architecture is depicted in FIG. 2A wherein a server computer 114 comprising a data base 116 and a central server 100 such as a Cytrix that is provided with client terminal working process 102, a stationary waiter working process 104 and a mobile waiter working process 106. Each process is corresponding and communicating with an appropriate terminal—a client terminal that can be optionally stationary 108 and/or mobile 118), a stationary waiter terminal 110, and a mobile waiter terminal 112. Mobile waiter terminal 112 is communicating with server 114 by a WiFi/WiMax connection but can also communicate through a BlueTooth, IR, FR oe cellular connection. This terminal is represented in FIG. 1 by a palm computer 26.

FIGS. 2 B and C represent the terminal-server architecture of the client terminal and the mobile waiter station, respectively.

A client terminal is optionally comprising of a terminal 120 that is a Dumb Terminal such as a JackPC to which a mouse 122, and preferably wireless mouse, as well as biometric device 124 and a monitor 126 are connected. The input devices that are mentioned to be connected to terminal 120 are preferable, however, it is possible that other input devices will be connected to the terminal. As mentioned herein before, the biometric device can be incorporated within monitor 126 or mouse 122. Incorporation of members within the system will by no means reduce the coverage of the scope of the present invention.

In Figure C, in the case of the waiter station, both stationary and mobile stations can be utilized as a User Interface of the system and can be connected through a LAN or Wireless LAN to the server on which the main storage and database are found. In this figure, mobile computer 128 communicates through WiFi/WiMax connection to microphone and speaker 130. Every order is entered on the waiter station's User Interface is being transformed into a transmission state and then transmitted for further handling to the server. The server is preferably provided with Business Logic. The order is stored on the database and printed on the appropriate printer.

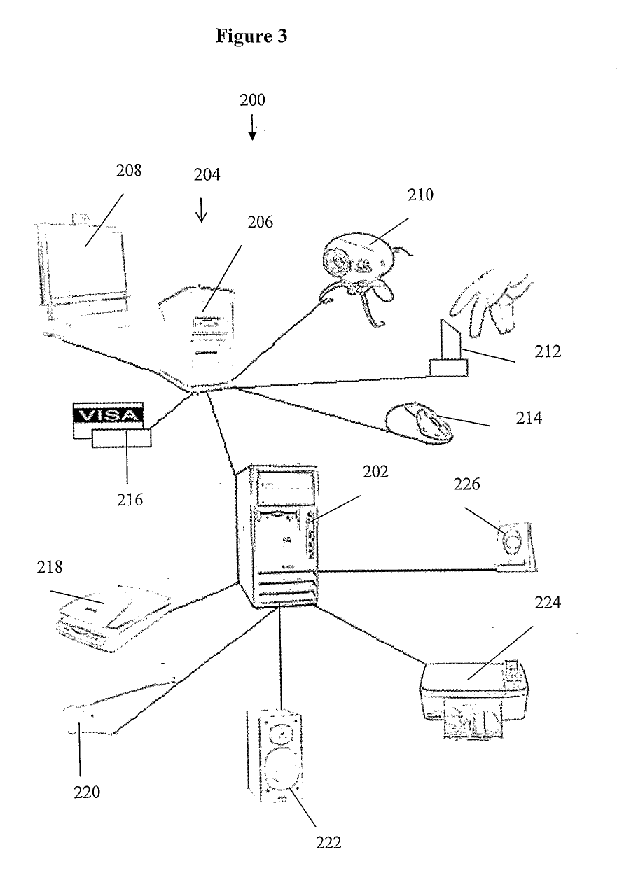

Reference is now made to FIG. 3 illustrating a hosting management system in accordance with a preferred embodiment of the present invention. This embodiment represents a web architecture in which a server 202 is provided to hosting management system 200. Server 202 is electrically communicating with a plurality of Customer's computer system 204 (optionally through LAN/Wireless LAN). Customer computer system 204 comprises a computer 206 that is an independent entity that is preferably electrically communicating with a screen monitor 208, a web camera 210, a biometric means 212, a mouse 214, and a payment means 216. All elements connected to customer computer 206 are adapted to facilitate the customer to interact and take full advantage of the hosting management system. A plurality of such customer computer systems is provided.

Server 202 can be provided with several input and output devices such as scanner 218, a microphone 220, speakers 222, printer 224, and odor spread device 226.

The advantage of using a biometric mouse or any mouse instead of a touch screen is that any person that seats near the table has an access to the mouse and the screen can be located distantly of the table so as to allow comfort. One screen can serve more than one table.

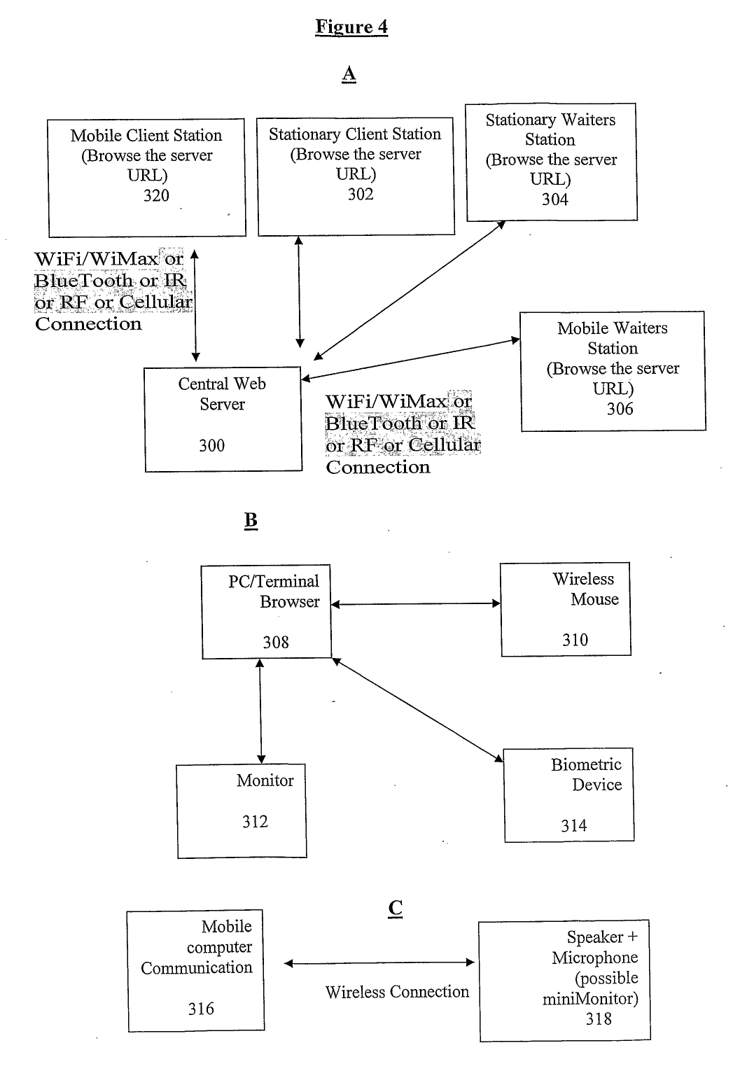

Reference is now made to FIG. 4 illustrating a block diagram of Web architecture for a hosting management system of the present invention. The web architecture is depicted in FIG. 4A wherein a central server 300 is communicating with a customer station that can be a stationary 302 and/or mobile 320 stations, a stationary waiter station 304, and a mobile waiter station 306. Mobile waiter station 306 is communicating with server 300 preferably by a WiFi/WiMax or BlueTooth or IR or RF cellular connection.

FIGS. 4 B and C represent the web architecture of the customer station and the mobile waiter station, respectively. Basically, the system is similar to what is explained in the previous embodiment; however, a PC/terminal browser 308 is provided that is adapted to act as a computer. As previously mentioned, PC/terminal browser 308 can communicate with a mouse 310, a monitor 312, and a biometric device 314.

The waiter station, both stationary and mobile 316, is the User Interface of the system and can communicate through LAN or Wireless LAN to the server on which the Web Server and/or main storage and database are found. In every order that is entered on the waiter station's Web Interface (Web Browser), and then transmitted for further handling to the server, on the server; the Business Logic is executed and the order is stored on the database and printed on the appropriate printer. Microphone and speaker 318 is preferably communicating with mobile computer 316.

While using this architecture—it is possible for a user to surf to the location, in this case the restaurant's web site, order his meal for takeaway and pay the bill. The customer can do these actions from any other location.

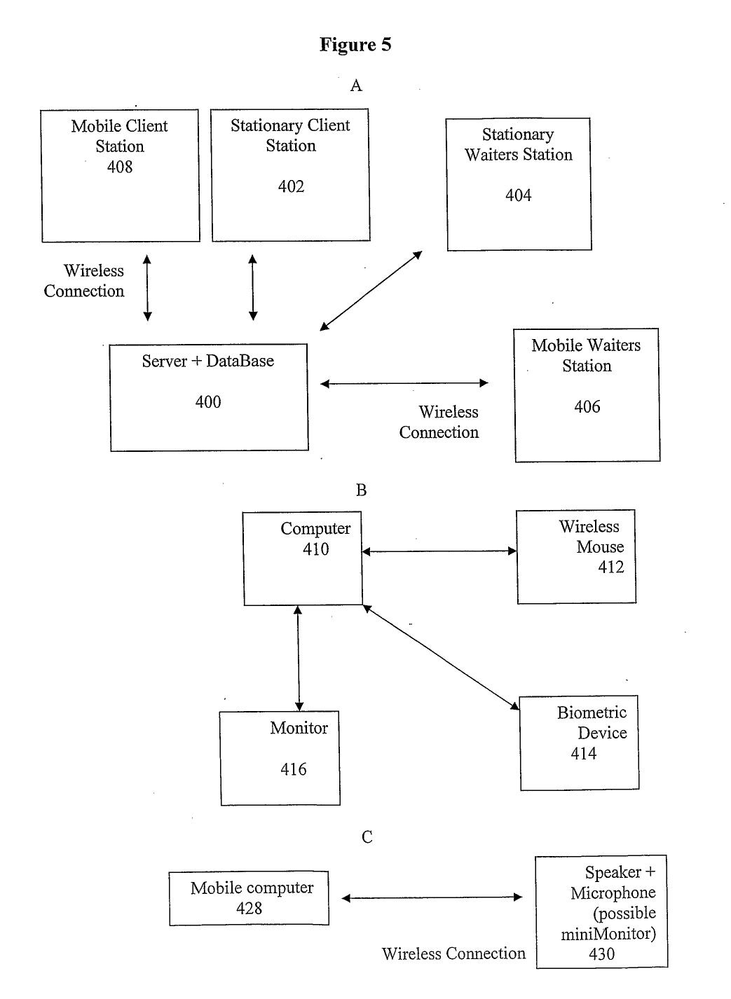

Reference is now made to FIG. 5 illustrating a block diagram of client-server architecture for a hosting management system in accordance with another preferred embodiment of the present invention. This architecture can be implemented in the embodiment shown herein in FIG. 3, as an example Using this architecture, a server 400, is provided with a central database. It is important to notice that the central database is an updating database that can be updated on-line according to the changing habits, orders, and queries of a specific customer. A customer station that can optionally be stationary 402 and/or mobile 408 is connected to server 400 preferably through active X data objects (ADO) and using LAN and/or Wireless LAN connections. Two types of waiter's stations can communicate with server 400, a stationary waiter station 404 and a mobile station 406. Both can be connected to server 400 through an ADO. Using this architecture, the customer that can be identified by the system can communicate with the system through any other computer provided with an Internet and in another location and use the system as mentioned herein before.

FIGS. 5 B and C represent the client-server architecture of the client station and the mobile waiter station, respectively.

A client station is comprised of a computer 410, to which a mouse 412, and preferably wireless mouse, as well as biometric device 414 and a monitor 416 are connected. The input devices that are mentioned to be connected to computer 410 are preferable, however, it is possible that other input devices will be connected to the computer. As mentioned herein before, the biometric device can be incorporated within monitor 416 or mouse 412. Incorporation of members within the system will by no means reduce the coverage of the scope of the present invention

In Figure C, in the case of the waiter station, both stationary and mobile stations can be utilized as a User Interface of the system and can be connected through a LAN or Wireless LAN to the server on which the main storage and database are found. In this figure, mobile computer 428 communicates through WiFi/WiMax connection or any other type of wireless connection to microphone and speaker 430. Every order is entered on the waiter station's User Interface is being transformed into a transmission state and then transmitted for further handling to the server. The server is preferably provided with Business Logic. The order is stored on the database and printed on the appropriate printer.

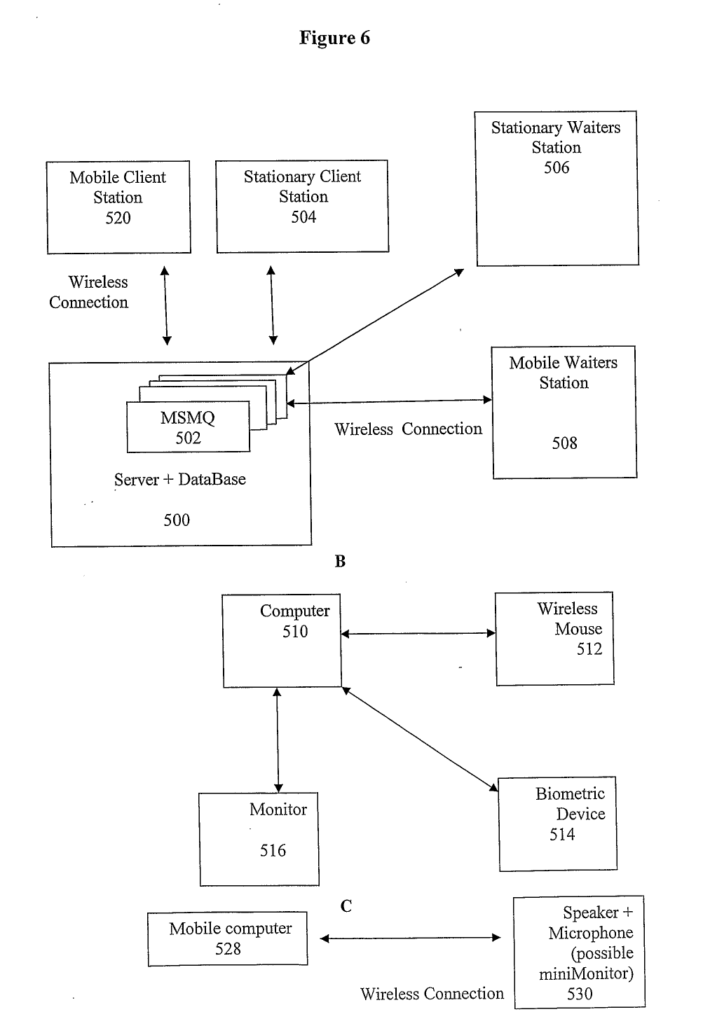

Reference is now made to FIG. 6 illustrating a block diagram of client-server architecture for a hosting management system in accordance with yet another preferred embodiment of the present invention. This architecture can be implemented in the embodiment shown herein in FIG. 3, as an example. Using this architecture, a server 500 is provided with a central database. Server 500 is provided with a queuing platform such as Microsoft massage queuing 502. A customer station that can be stationary 504 and/or mobile 520 is connected to server 500 preferably through ADO. Two types of waiter's stations can communicate with server 500, a stationary waiter station 506 and a mobile station 508. Both can be connected to server 500 through an ADO and all the stations connected to server 500 are communicating with the server preferably through MSMQ system. The queuing system is provided in order to facilitate the management of many orders that can be placed into the system simultaneously.

FIGS. 6 B and C represent the client-server architecture of the client station and the mobile waiter station, respectively. A client station is comprised of a computer 510, to which a mouse 512, and preferably wireless mouse, as well as biometric device 514 and a monitor 516 are connected. The input devices that are mentioned to be connected to computer 510 are preferable, however, it is possible that other input devices will be connected to the computer. As mentioned herein before, the biometric device can be incorporated within monitor 516 or mouse 512. Incorporation of members within the system will by no means reduce the coverage of the scope of the present invention

In Figure C, in the case of the waiter station, both stationary and mobile stations can be utilized as a User Interface of the system and can be connected through a LAN or Wireless LAN to the server on which the main storage and database are found provided. In this figure, mobile computer 528 communicates through WiFi/WiMax connection or any other type of connection to microphone and speaker 530. Every order is entered on the waiter station's User Interface is being transformed into a transmission state and then transmitted for further handling to the server. The server is preferably provided with Business Logic. The order is stored on the database and printed on the appropriate printer.

It should be noted that the identification means used in the hosting management system of the present invention can be any biometric means as the one discussed herein before, the fingerprint option. Examples of other biometric means are retinal identification, vocal identification or biodynamic signature in which characteristic electric pulses of the user are identified, magnetic card, user name and password identification. The use of any other identification means is covered by the scope of the present invention.

Since the customer is identified by the computer, the system can also provide a virtual signature feature by which the customer can sign his bills for the services.

Optionally, the customer computer system is further provided with a microphone for vocal messages, a webcam for photo identification or other purposes, and speakers. The webcam can be used also for transferring photos through electronic mail or transferring messages through the net.

Since in one embodiment of the present invention, the computers are associated with a server, games can be loaded on the computer for the amusement of the people in the restaurant. For example, the game can be played by people sitting in one table or can be a game that cooperates several tables. The games can be free of charge or charged. When the server is connected through a net such as an internet, the games can be played by customers from more than one restaurant. Songs can be ordered through the system and played in a predetermined area of the restaurant or in several places. Games associated with the songs can be played too. One of the unique features that can be employed in such a system due to the possibility of identification is that bets can be made between the people that are in the restaurant and people from several restaurants. The bets can be made for details such as prices of a meal etc.

Commercials and advertisements can be viewed on the screens of the computer also. Products can be given as prices for people that win a game that is played through the network of computers.

It should be mentioned that the system can provide on-line information on the availability of services in the restaurant or in a bigger place that provides different kinds of services.

The fact that the system can identify the customer in a biometric or another manner enables forming customer club in which the customers that usually come to the restaurant or the other facility that is using the hosting management system of the present invention can be identified and their preferences are known to the system. The system can interactively connect with the customer wishing him happy birthday, for example, or interact on any bases due to the database in which the customer's details are provided.

Examples for services that can be directly managed by the hosing management system of the present invention are as follows:

Orders by customers, the system can provide to data regarding the offered courses or services;

Games—games can be played by a certain user, by the users in a table or an interactive game used by several tables;

Order of songs;

### Commercials;

Sales through the computers;

### Ads;

Matchmaking system;

### E-mailing;

Follow-up of the orders;
Changing courses;
Creating courses;
Information regarding taken or ordered table;
Reservation of table or places in advance;
Poles in order to improve the service in the restaurant;

### T.V.

### Karaoke.

This list brings several examples in which the system can be used however, any other use of such system is covered by the scope of the present invention.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1. A hosting management system adapted to provide communication between service provider and customer in a location, the system comprising:
a server;
at least one customer computer system provided in the location communicating with said server and provided with identification means adapted to identify the customer.

2. The system as claimed in claim 1, further provided with at least one service provider computer unit communicating with said server.

3. The system as claimed in claim 2, wherein said at least one service provider computer unit is provided with identification means.

4. The system as claimed in claim 2, wherein a plurality of input devices is communicating with said at least one service provider computer unit.

5. The system as claimed in claim 1, wherein said identification means is a biometric means.

6. The system as claimed in claim 1, wherein Internet is provided to said server.

7. The system as claimed in claim 1, wherein Internet is provided to said at least one customer computer system.

8. The system as claimed in claim 1, wherein the system is further provided with cash register communicating with said server.

9. The system as claimed in claim 2, wherein said cash register is communicating with at least one of said at least one service provider computer unit.

10. The system as claimed in claim 1, wherein said location is selected from a group of locations such as restaurants, resorts, motels, hotels, spa resorts, budget accommodation, karaoke clubs, cafés, diners.

11. The system as claimed in claim 1, wherein a plurality of input devices is communicating with said at least one customer computer system.

12. The system as claimed in claim 1, wherein said at least one customer computer is adapted to provide on-line information related to the location.

13. The system as claimed in claim 1, wherein said server is communicating with said at least one customer computer systems using web architecture.

14. The system as claimed in claim 1, wherein said at least one customer computer system is a terminal of said server.

15. The system as claimed in claim 1, wherein said server is provided with an updated database provided with information related to the customer.

16. An improvement for a management hosting system providing communication between service provider and customer wherein the improvement comprises an identification means associated with the customer.

17. The improvement as claimed in claim 16, wherein said identification means is biometric.

18. A management system adapted to provide communication between service provider and customer in a location, substantially as described in the above specification, attached Figures and appending claims.
